(19) United States
(12) Patent Application Publication
(10) Pub. No.: US 2002/0186419 A1
(43) Pub. Date: Dec. 12, 2002

(54) Internet facsimile apparatus and method of updating setting information of the same

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/161,277

(22) Filed: May 31, 2002

(30) Foreign Application Priority Data
Jun. 8, 2001 (JP) 2001-174000

(51) Int. Cl. H04N 1/00

(52) U.S. Cl. 358/402

(57) ABSTRACT

An Internet facsimile apparatus by which communication terminals which can demand a specific process to the Internet facsimile apparatus are not limited, and an operation of demanding the specific process becomes easy. When the Internet facsimile apparatus receives e-mail demanding the specific process via a communication network, the Internet facsimile apparatus refers to header information of the received e-mail demanding the specific process, and makes authentication based on whether or not the header information includes a mail address of a particular apparatus together with a mail address of the Internet facsimile apparatus itself. In this manner, it is determined whether or not the demanded specific process is performed.

### CROSS REFERENCES TO RELATED APPLICATIONS

This application claims priority under 35 USC 119 of Japanese Patent Application No. 2001-174000 filed in JPO on Jun. 8, 2001, the entire disclosure of which is incorporated herein by reference.

### BACKGROUND OF THE INVENTION

1. Field of the Invention

The present invention relates to improvement of an Internet facsimile apparatus for performing a demanded specific process based on information written in e-mail which demands the specific process, and has been received via a communication network.

2. Description of the Related Art

When an Internet facsimile apparatus receives e-mail demanding a specific process via a communications network, the Internet facsimile apparatus can perform the demanded specific process based on information written in the e-mail, for example, update its own setting information (i.e., the setting information of the Internet facsimile apparatus), and enables the machine, which is a transmitter of this e-mail, to refer to the setting information of the Internet facsimile apparatus.

Such an Internet facsimile apparatus prevents unauthorized updating of and unauthorized reference to the setting information by authenticating the transmitter of the e-mail by using a mail address of the transmitter and a password written in the e-mail text. However in this case, it is inconvenient as mail addresses of transmitters are limited, and the only particular communication terminals can make the updating of and reference to the setting information. In addition to that, it is a troublesome matter to write a password in the text of the e-mail.

### SUMMARY OF THE INVENTION

With the view of the foregoing, it is an object of the present invention to provide an Internet facsimile apparatus in which communication terminals which can demand a specific process are not limited, and an operation for demanding the specific process can be carried out easily.

In order to accomplish the above object, there is provided an Internet facsimile apparatus in which when the Internet facsimile apparatus receives e-mail demanding a specific process via a communication network, the Internet facsimile apparatus refers to header information of the e-mail demanding the specific process, and makes authentication based on whether or not the header information includes a mail address designating a particular apparatus together with a mail address of its own apparatus (i.e., together with the Internet facsimile apparatus which has received the e-mail) in order to determine whether to carry out the demanded specific process. Accordingly, communication terminals which can demand the specific process are not limited, and an operation for demanding the specific process becomes easy.

Preferably, the Internet facsimile apparatus includes a receiving unit for receiving e-mail via a communication network, an authentication unit for making authentication by referring to header information of the received e-mail and determining whether or not the header information includes a mail address designating a particular apparatus along with a mail address of the Internet facsimile apparatus, and a specific process performing unit for performing a specific process which is demanded by the e-mail, when the authentication unit determines that the header information includes the mail address designating the particular apparatus. The Internet facsimile apparatus preferably further includes a communication management recording unit for recording a result of the performed specific process.

Particularly, the e-mail demanding thes specific process is sent to not only the Internet facsimile apparatus but also the particular apparatus. For example, if an apparatus of a manager is set as the particular apparatus, the e-mail demanding the specific process is sent also the apparatus of the manager. As a result, it is possible to prevent a service center from causing the Internet facsimile apparatus to carry out the specific process without making the notification to the apparatus of the manager. Accordingly, this manner is useful in preventing unauthorized use.

With this Internet facsimile apparatus, in the case where the specific process is a process of updating setting information of the Internet facsimile apparatus, any communication terminal can transmit to the Internet facsimile apparatus the e-mail whose header information includes the designated specific process so as to demand the updating of the setting information of the Internet facsimile apparatus, becoming more convenient.

Additional objects, aspects, benefits and advantages of the present invention will become apparent to those skilled in the art to which the present invention pertains from the subsequent detailed description and the appended claims, taken in conjunction with the accompanying drawings.

### BREIF DESCRIPTION OF THE DRAWINGS

FIG. 1 is a diagram showing main structure of an Internet facsimile apparatus according to an embodiment of the present invention;

FIG. 2 is an illustration showing an example of use of the Internet facsimile apparatus shown in FIG. 1;

FIG. 3 is a flow chart showing an example of an operation of the Internet facsimile apparatus shown in FIG. 1; and

FIG. 4 is an illustration showing an example of e-mail demanding the update.

### DETAILED DESCRIPTION OF THE INVENTION

Hereinafter, a preferred embodiment of the present invention will be described with reference to the drawings.

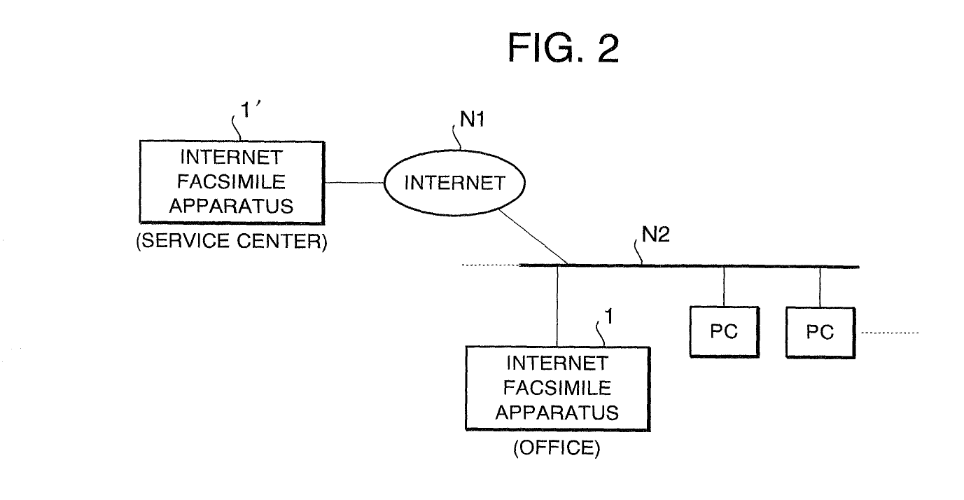

As shown in FIG. 2, the Internet facsimile apparatus 1 is connected to a LAN N2 to which a communication terminal (for example, a personal computer) is connected. The LAN N2 is connected to the Internet N1.

It should be noted that combination of the Internet N1 and the LAN N2 is shown as a communication network in this example. However, the present invention is not limited to this example, and a communication network may be constituted by another kind of network such as a WAN, a LAN, and leased lines, or by combination thereof.

This Internet facsimile apparatus 1 can receive and send image data as an attached file of e-mail based on a predetermined protocol through the LAN N2 and the Internet N1. This Internet facsimile apparatus 1 can also receive and send image data as an attached file of e-mail based on a predetermined protocol through the LAN N2.

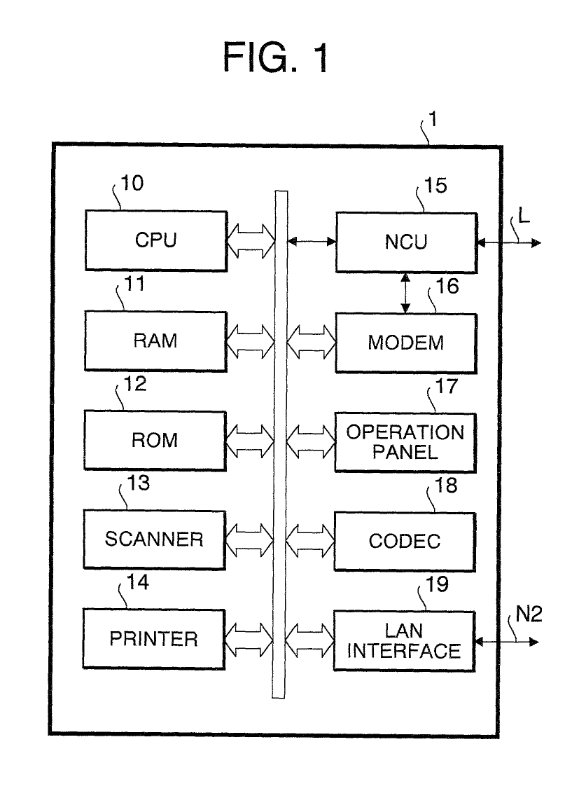

As illustrated in FIG. 1, the Internet facsimile apparatus 1 is equipped with a CPU 10 for controlling following each unit, a RAM 11 for storing received data and various setting information such as a speed dial and the like, a ROM 12 for memorizing a control program, etc. in advance, a scanner 13 for reading image data from a document, a printer 14 for recording data on predetermined recording paper, an NCU 15 for controlling a connection to a telephone line L, a modem 16 for modulating and demodulating various signals necessary for facsimile communication, an operation panel 17 comprising a liquid crystal display and various control keys, etc., a CODEC 18 for coding and decoding data by an MH, an MR, or an MMR coding scheme for facsimile communication, and a LAN interface 19 for making the connection with the LAN N2 based on the standard of the Ethernet or the like.

With the above-described structure, for example, an Internet facsimile apparatus 1′ located at a service center (refer to FIG. 2) can transmit, to the Internet facsimile apparatus 1 located at the office, e-mail which demands a specific process of updating or making reference to the setting information registered in the Internet facsimile apparatus 1 located at the office (refer to FIG. 2) in order to cause the Internet facsimile apparatus 1 to perform the process based on this demand. The location of the Internet facsimile is not limited to the office.

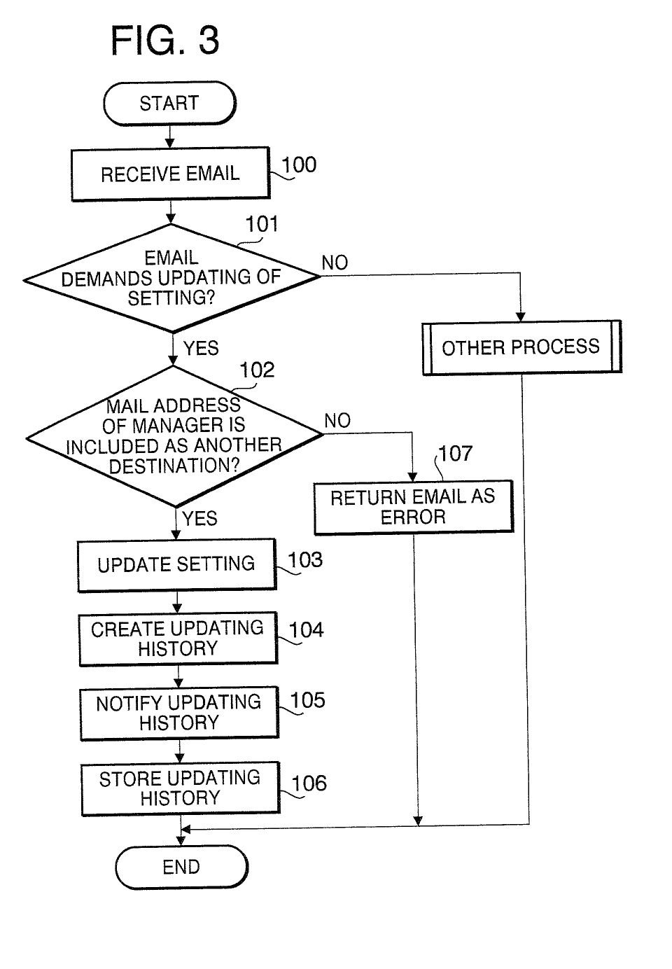

This demand operation will be described with reference to a flow chart of FIG. 3. Specifically, when the Internet facsimile apparatus 1 located at the office receives e-mail via the Internet N1 and the LAN N2 (in the step 100), the Internet facsimile apparatus 1 determines whether or not the received e-mail demands a specific process (for example, the specific process is updating of the setting information), based on a command written in header information of the received e-mail (in the step 101). In the step 101, the command of the specific process may be extracted from the header information of the received e-mail, and if the extraction of the command of the specific process succeeds, it may be determined that the received e-mail demands the specific process. If it is determined that the updating of the setting information is not demanded, other processes are carried out, but if it is determined that the updating of the setting information is demanded, the Internet facsimile apparatus 1 performs the following processes.

In other words, the CPU 10 refers to the header information of the received e-mail, and makes authentication based on whether or not the header information includes a mail address designating a particular apparatus as CC (carbon copy) or BCC (blind carbon copy) along with a mail address designating the Internet facsimile apparatus 1 itself (in the step 102). For example, this mail address designating the particular apparatus as CC or BCC is a mail address designating an apparatus of a manager.

Furthermore, this authentication may be carried out based on whether or not a mail address of a manager is specified in the header information of the received e-mail as “TO” along with the mail address of the Internet facsimile apparatus 1 itself.

When the header information of the received e-mail includes the mail address of the manager, the CPU 10 updates the setting information based on the contents of the received e-mail (in the step 103).

Subsequently, the CPU 10 creates communication management record including an updating history (in the step 104), and makes a format of the created communication management record a predetermined format to transmit the communication management record as e-mail by designating a mail address of a communication terminal 2, to transmit the communication management record by facsimile to other facsimile apparatus, or to print out the communication management record by the Internet facsimile apparatus 1 itself (in the step 105). In addition, the CPU 10 causes the RAM 11 to store the created communication management record (in the step 106).

Furthermore, the communication management record may be stored in the RAM 11 as HTML data, and when the communication terminal 2 access the Internet facsimile apparatus 1, the Internet facsimile apparatus 1 may transmit the communication management record based on the demand from this communication terminal 2, becoming more convenient.

On the other hand, when the header information does not include the e-mail address designating the particular apparatus such as the apparatus of the manager along with the mail address of the Internet facsimile apparatus 1 itself, the CPU 10 determines that the updating demand is illegal or unauthorized, and sends a reply including a warning message to the transmitter of the e-mail, or ignores the received e-mail.

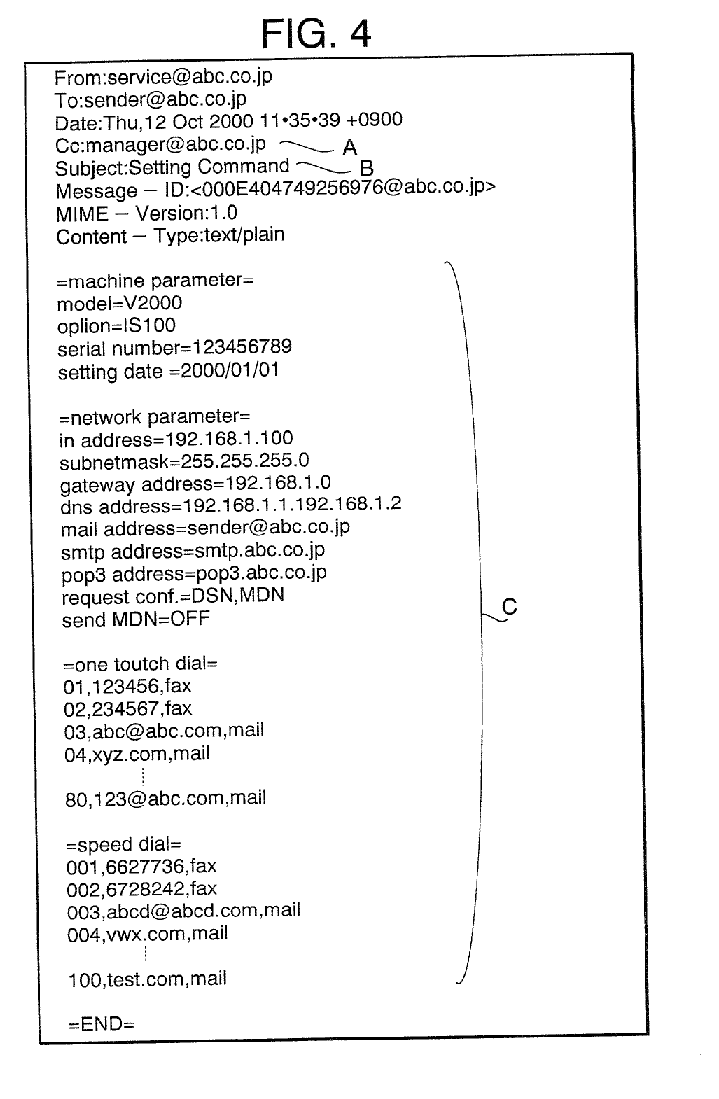

As shown in FIG. 4, the mail address “A” designating the apparatus of the manger is written as “CC” in the header information. The Internet facsimile apparatus 1 can make the authentication based on whether or not there is this mail address “A”.

Furthermore, an updating demand command “B” is written as “Subject” in the header information, and the Internet facsimile apparatus 1 can determine whether or not this e-mail demands the updating of the setting information, based on the existence of the updating demand command “B”.

In addition to that, the updating contents “C” are written in the text of the e-mail, and the Internet facsimile apparatus 1 can carry out the updating based on this updating contents “C”.

It should be noted that the present invention is not limited to the above-described embodiment, but the present invention may be embodied in other specific forms without departing from the spirit or characteristics thereof. The above-described embodiment is therefore to be considered in all respects as illustrative and not restrictive.

What is claimed is:

1. An Internet facsimile apparatus comprising:
a receiving unit for receiving e-mail via a communication network;
an authentication unit for making authentication by referring to header information of the received e-mail and determining whether or not a mail address is included in the header information of the received e-mail along with a mail address of the Internet facsimile apparatus; and
a specific process performing unit for performing a specific process which is demanded by the e-mail, when the authentication unit determines that the header information includes the mail address designating the particular apparatus.

2. The Internet facsimile apparatus according to claim 1, wherein the specific process is a process of updating setting information of the Internet facsimile apparatus.

3. The Internet facsimile apparatus according to claim 1, wherein the authentication unit determines whether or not the mail address designating the particular apparatus is included in CC (carbon copy) of the header information.

4. The Internet facsimile apparatus according to claim 1, wherein the authentication unit determines whether or not the mail address designating the particular apparatus is included in BCC (blind carbon copy) of the header information.

5. The Internet facsimile apparatus according to claim 1, wherein a command of the specific process is included in the header information.

6. The Internet facsimile apparatus according to claim 5, wherein detailed information of the specific process is included in text of the e-mail.

7. The Internet facsimile apparatus according to claim 1 further including a communication management recording unit for recording a result of the performed specific process.

8. An Internet facsimile apparatus comprising:
receiving means for receiving e-mail via a communication network;
authentication means for making authentication by referring to header information of the received e-mail and determining whether or not a mail address is included in the header information of the received e-mail along with a mail address of the Internet facsimile apparatus; and
specific process performing means for performing a specific process which is demanded by the e-mail, when the authentication means determines that the header information includes the mail address designating the particular apparatus.

9. The Internet facsimile apparatus according to claim 8, wherein the specific process is a process of updating setting information of the Internet facsimile apparatus.

10. The Internet facsimile apparatus according to claim 8, wherein the authentication means determines whether or not the mail address designating the particular apparatus is included in CC (carbon copy) of the header information.

11. The Internet facsimile apparatus according to claim 8, wherein the authentication means determines whether or not the mail address designating the particular apparatus is included in BCC (blind carbon copy) of the header information.

12. The Internet facsimile apparatus according to claim 8, wherein a command of the specific process is included in the header information.

13. The Internet facsimile apparatus according to claim 12, wherein detailed information of the specific process is included in text of the e-mail.

14. The Internet facsimile apparatus according to claim 8 further including communication management recording means for recording a result of the performed specific process.

15. A method of updating setting information of an Internet facsimile apparatus, comprising the steps of:
a) receiving e-mail;
b) determining whether or not the received e-mail demands a specific process;
c) determining whether or not a particular mail address is included in header information of the received e-mail along with a mail address of the Internet facsimile apparatus, when the received e-mail demands the specific process; and
d) performing the specific process when the header information includes the particular mail address.

16. The method of updating the setting information of the Internet facsimile apparatus according to claim 15, wherein in the step b), a command of the specific process is extracted from the header information of the received e-mail, and if extraction of the command of the specific information succeeds, it is determined that the received e-mail demands the specific process.

17. The method of updating the setting information of the Internet facsimile apparatus according to claim 15, wherein in the step c), it is determined whether or not the particular mail address is included in CC (carbon copy) of the header information.

18. The method of updating the setting information of the Internet facsimile apparatus according to claim 15, wherein in the step c), it is determined whether or not the particular mail address is included in BCC (blind carbon copy) of the header information.

19. The method of updating the setting information of the Internet facsimile apparatus according to claim 15, wherein in the step d), the specific process is performed based on information written in text of the received e-mail.

20. The method of updating the setting information of the Internet facsimile apparatus according to claim 15, further including the step e) of recording a result of the performed specific process in a communication management record after the step d).
